(19) United States
(12) Patent Application Publication
(10) Pub. No.: US 2009/0179013 A1
(43) Pub. Date: Jul. 16, 2009

(54) LASER WELDING PROCESS

(75) Inventor: James B. Toeniskoetter, Rochester Hills, MI (US)

Correspondence Address: FILDES & OUTLAND, P.C., 20916 MACK AVE., SUITE 2, GROSSE POINTE WOODS, MI, 48236, US

(73) Assignee: HIROTEC AMERICA, INC., Auburn Hills, MI (US)

(21) Appl. No.: 12/348,458

(22) Filed: Jan. 5, 2009

Related U.S. Application Data
(60) Provisional application No. 61/010,614, filed on Jan. 10, 2008.

(51) Int. Cl. B23K 26/20

(52) U.S. Cl. 219/121.64; 219/121.63

(57) ABSTRACT

A method of laser welding metal automotive panel assemblies includes loading a panel and parts to be welded thereto onto a support anvil; engaging a pressure pad/clamping anvil and clamping the anvils together with adequate force on the pressure pad to maintain alignment of the panel and parts, the anvil including access locations, such as holes, for admitting laser welding beams to the panel and parts locations to be welded; and actuating a laser welding gun to direct the welding laser beams through the access locations and weld the parts and panel together into an assembly. The method may further include applying welding flux to the panel locations to be welded, applying locating and clamping devices between the anvils and applying adequate holding force while maintaining alignment of the anvils, resulting in positive fit up for welding.

### CROSS REFERENCE TO RELATED APPLICATION

This application claims priority from U.S. Provisional Patent Application No. 61/010,614 filed Jan. 10, 2008.

### TECHNICAL FIELD

This invention relates to tooling and methods used in conjunction with laser welding in automotive bodyshop assembly processes.

### BACKGROUND OF THE INVENTION

It is known in the art relating to laser welding processes for automotive bodyshop assembly that laser welding requires very accurate part fit up that is not possible with localized fixture style part locating and clamping mechanisms. The requirement of full ring clamping increases fixture size along with requiring increased size of motion devices to move rings for product load and unload clearances.

### SUMMARY OF THE INVENTION

The present invention provides a process using a large capacity robot carrying a PRESSURE PAD/ANVIL, a clamping anvil and pressure pad, with localized laser welding holes, which makes it practical to use a long focal length laser for welding of automotive panel assemblies. The laser may be mounted to a stationary pedestal or carried on another anvil by a robot working in conjunction with the robot carrying the pressure pad/clamping anvil, the panel assembly and the support anvil.

The pressure pad may be engaged to the support anvil by a clamping mechanism and provides a continuous pressure surface along any length of panel flange that is to be welded by a laser.

The assembly sequence may include, but is not limited to, loading a panel to anvil, applying flux material, marrying panels, engaging the pressure pad, laser welding, releasing pressure pad or anvil, unloading welded panel, and returning to start.

Through the use of robotic exchangers it becomes possible to have product model mix with anvil and pressure pad change out.

Optionally, a wire brush motor on a pedestal may also be incorporated into the process cell and used to clean any weld flash from the pressure pad or anvil weld access holes.

These and other features and advantages of the invention will be more fully understood from the following detailed description of the invention taken together with the accompanying drawings.

### BRIEF DESCRIPTION OF THE DRAWINGS

In the drawings:

FIG. 1 is a top view of an exemplary hood inner panel with latch, hinge, and cowl reinforcements loaded thereon for laser welding into an assembly;

FIG. 2 is an exploded view of the assembly elements of FIG. 1 loaded on a robot lower support anvil (end of arm tool) for processing;

FIG. 3 is a perspective view showing the application of degassing flux to the welding locations of the assembly elements;

FIG. 4 is a perspective view showing the assembly elements (panel and reinforcements) held on the lower anvil by a pressure pad/upper spider anvil with clamping mechanisms providing holding force;

FIG. 5 is an enlarged view of a portion of FIG. 4 showing a register pin clamping mechanism applying a holding force between the anvils;

FIG. 6 is a top view of the welding assembly showing the pressure pad style distributed clamping and weld access holes through the pressure pad/upper anvil;

FIG. 7 is a perspective view of a laser welding step;

FIG. 8 is a perspective view of a robot returning the welded panel assembly with the pressure pad/upper anvil to a holding or unloading station; and

FIG. 9 is a chart showing various process variations illustrating flexibility of the welding process for various assemblies.

### DETAILED DESCRIPTION OF THE INVENTION

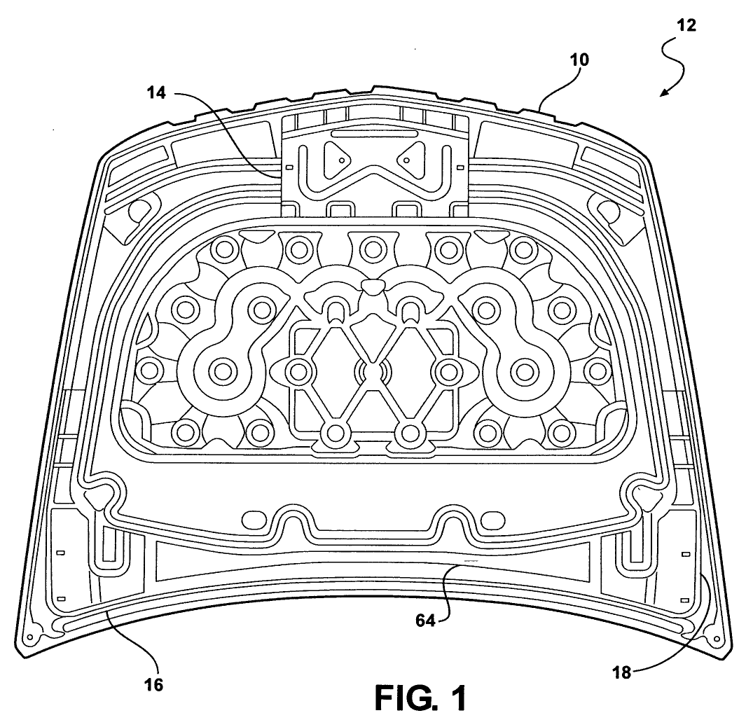

Referring now to FIG. 1 of the drawings in detail, numeral 10 generally indicates, for example, a hood inner panel prepared for welding into a panel assembly 12. Assembly 12 includes the inner panel 10, prepared with added parts that are loaded in position for laser welding onto the inner panel 10. The added parts include a hood latch reinforcement 14, a cowl reinforcement 64, and two hinge reinforcements 16, 18.

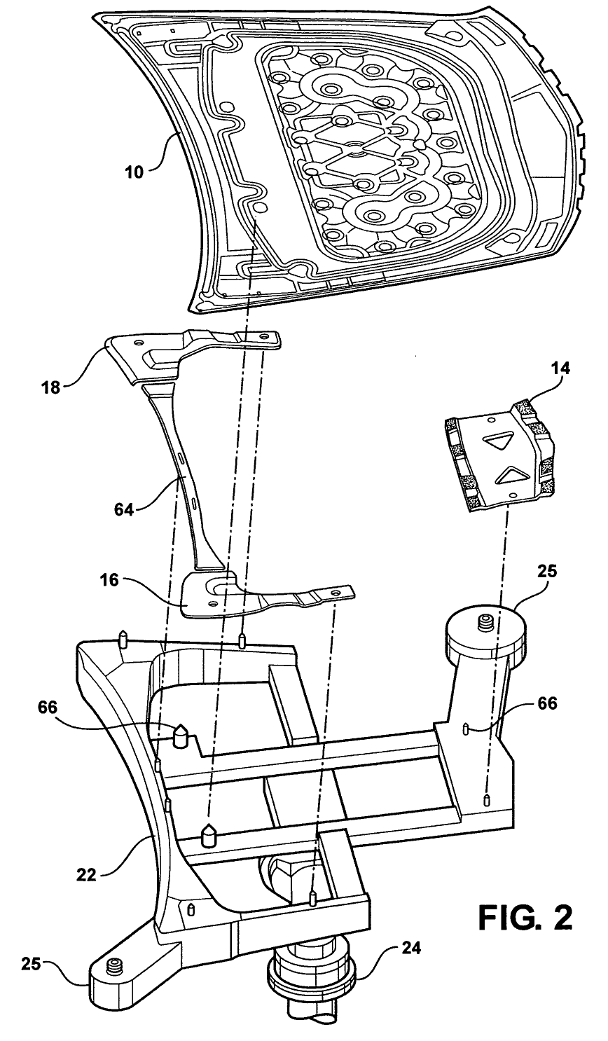

FIG. 2 illustrates sequential loading of the reinforcements 14, 16, 18, and 64 onto a lower anvil 22 supported by the end of arm 24 of a robot. The inner panel 10 is then loaded to the lower anvil 22. Additional processes may be added in between the loading of the reinforcements 14, 16, 18, 64, and the inner panel 10. These may include flux application to the reinforcements or the inner panel, and may also include a vision inspection of the flux application. The parts may be loaded manually, mechanically or robotically onto the lower anvil 22. The reinforcements 14, 16, 18, 64 and inner panel 10 will be located to the anvil 22 by means of locating pins 66, net blocks or other devices to properly and securely position them with respect to each other. The lower anvil 22 includes oppositely disposed lower clamping projections 25 to be further described.

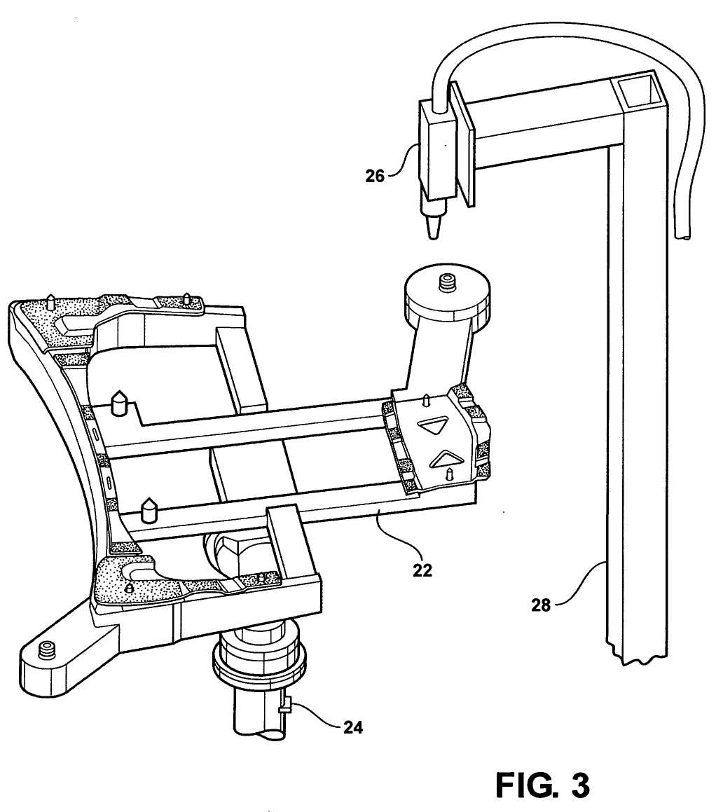

FIG. 3 shows the application of welding flux at several positions to the parts to be welded. The flux is applied by a flux applying gun 26 supported on a pedestal 28 while the robot end of arm 24 holds the lower anvil 22 horizontal below the gun to receive the flux. Either the anvil 22 or the gun 26 may be moved to the several positions for applying the flux.

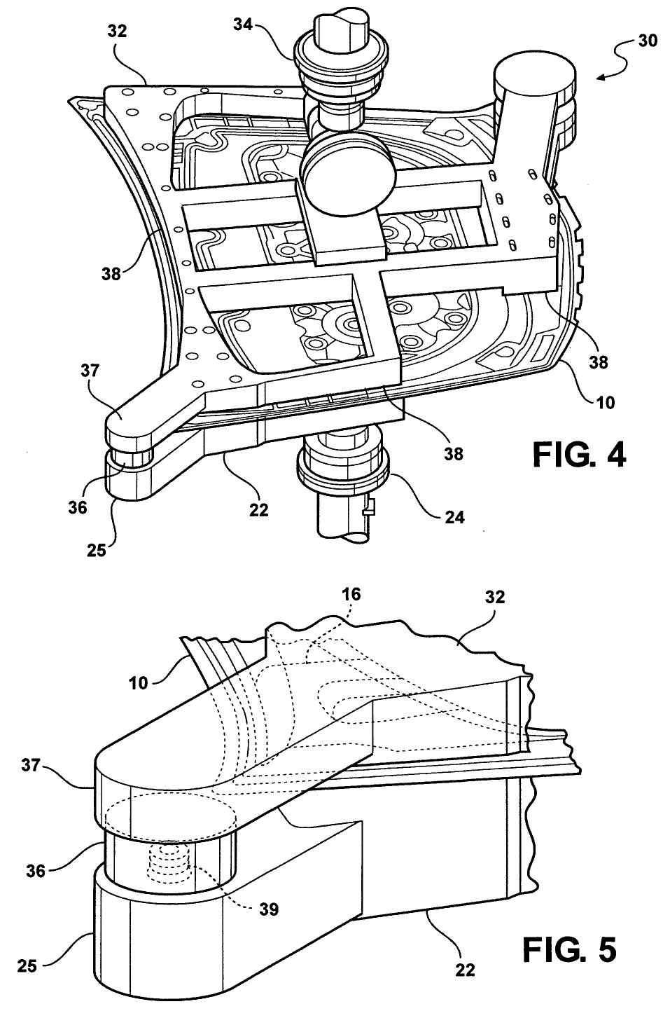

FIG. 4 illustrates a completed welding assembly 30 formed by applying an upper pressure pad/anvil 32, carried by an upper robot end of arm 34, on top of the inner panel 10 and parts 14, 16, 18, 64 to be welded. Clamping mechanisms 36 engage upper clamping projections 37 of the upper pressure pad/anvil 32 and the lower clamping projections 25 of the lower anvil 22 and apply clamping force holding the upper and lower anvils 32, 22 tightly together to retain the inner panel 10 and parts to be welded in position for welding. The pressure pad/anvil 32 is provided with continuous clamping surfaces 38 which engage any length of panel flange that is to be welded by a laser.

FIG. 5 shows one form of clamping mechanism 36 that may be applied to hold the upper pressure pad 32 and lower anvil 22 together on the panel flanges and hold the panel assembly elements together. At least two clamping mechanisms 36, engaging the lower and upper clamping projections 25, 37 at opposite edges of the pressure pad 32 and lower anvil 22, are preferred to locate the inner panel 10 and reinforcements 14, 16, 18, 64 accurately and create positive fit up of the parts for welding. The clamping mechanisms 36 may be pneumatic, hydraulic, electric or manual but must have a high capacity holding force adequate to maintain the positions of the panel and parts during processing and welding. The mechanisms 36 may include register pins 39 or equivalents which prevent misalignment of the pressure pad 32 and lower anvil 22. In the figure, the pressure pad 32 and illustrative panels to be welded are shown in phantom for clarity.

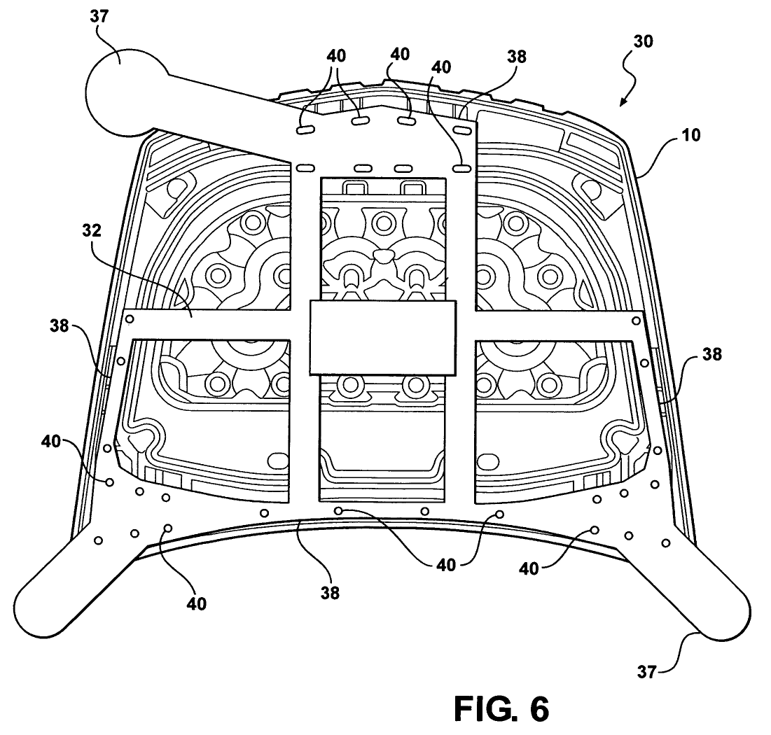

FIG. 6 is a pictorial top view of the welding assembly 30 showing weld access holes 40 through the pressure pad/upper anvil 32. The locations of the clamping surfaces 38 are indicated along the near edge, sides and far end of the inner panel 10. The clamping projections 37 of the upper pressure pad/anvil 32 are shown at opposite edges thereof.

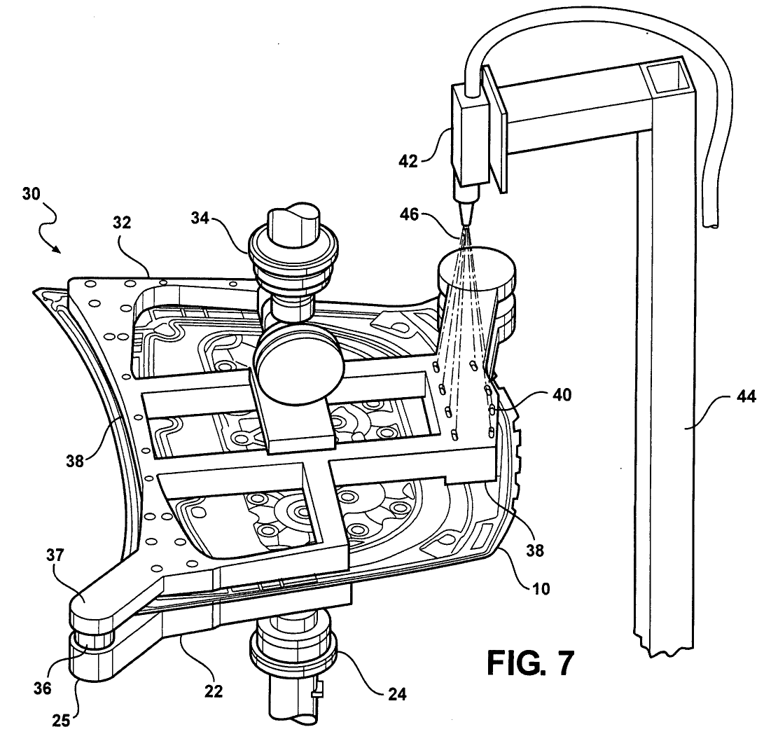

FIG. 7 illustrates the welding step wherein the welding assembly 30 is held horizontal by the lower robot 24. A laser gun 42 on a pedestal 44 is positioned over each set of access holes 40 and the laser beams 46 are directed through the access holes 40 for accurately welding the panel 10 and parts 14, 16, 18, 64 in the required positions. The laser 42 may be actuated with a long or short focal length as required by the configurations of the components being welded. The projections 25, 37 and the clamping mechanisms 36 holding the lower and upper anvils 22, 32 in accurate welding positions are also shown in FIG. 7.

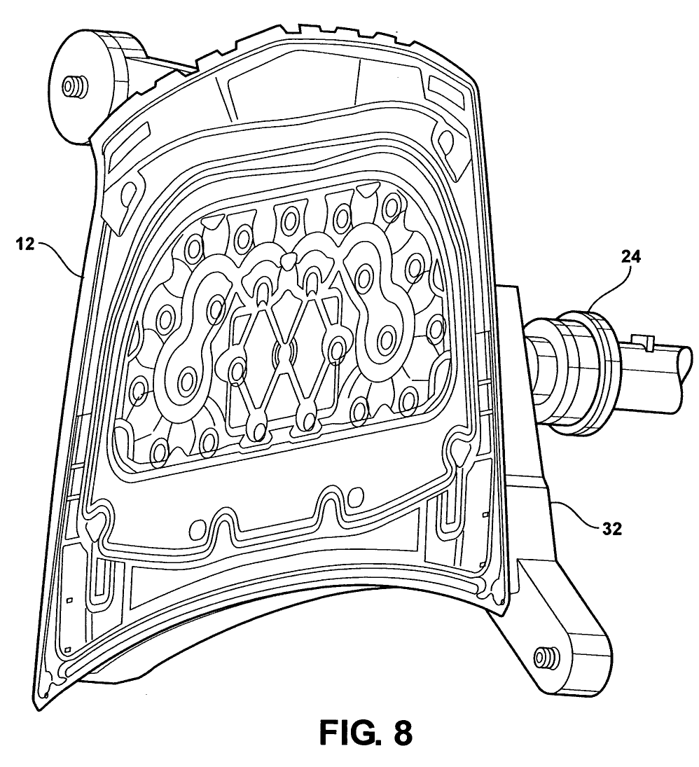

FIG. 8 illustrates the lower robot 24 returning the welded panel assembly 12 and lower anvil 22 to a holding or unloading station.

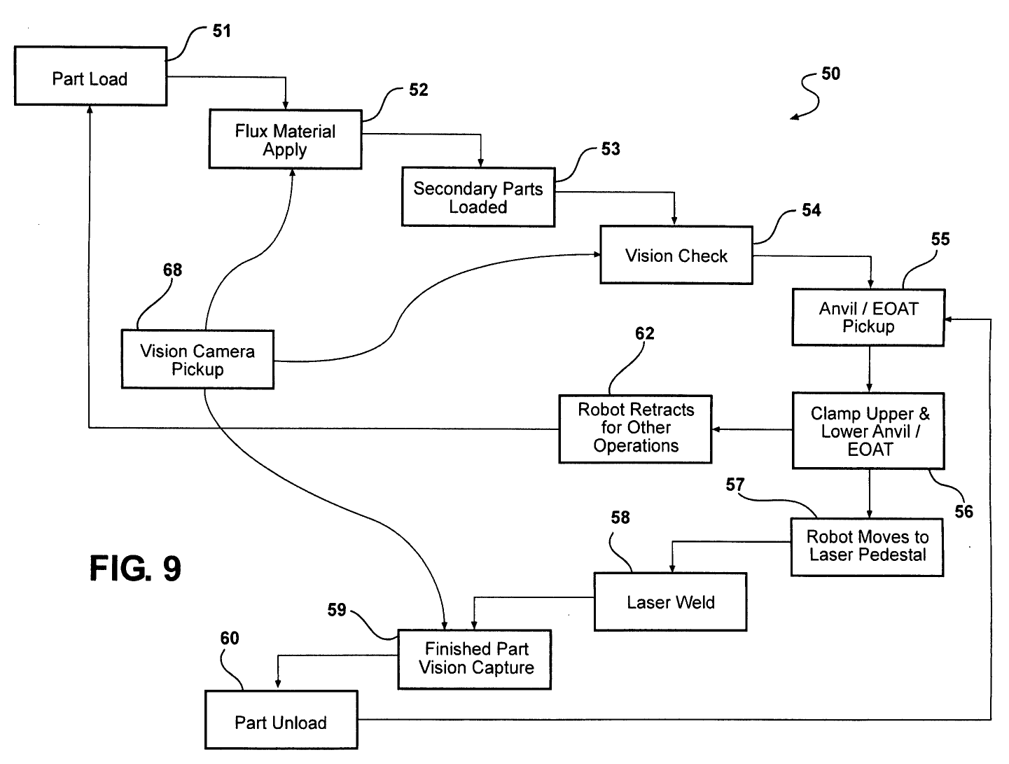

FIG. 9 is a flow chart 50 showing some of the multiple process sequences that may be practiced using the apparatus features disclosed in the foregoing figures and description relating to the present invention.

In the chart:

Box 51 indicates the step of loading the reinforcement parts 14, 16, 18, 64 onto the lower anvil 22 carried by robot 24;

Box 52 indicates the application of welding flux to the panel locations to be welded;

Box 53 indicates the loading of related secondary parts or inner panel 10 onto the lower anvil 22;

Box 54 indicates vision inspection of the loaded panel 10 and parts 14, 16, 18, 64 for proper positioning;

Box 55 indicates pickup and marriage of the upper pressure pad/anvil 32 with the panel upper surface;

Box 56 indicates clamping of the top and bottom anvils 22, 32 together;

Box 57 indicates movement of the lower robot 24 to the laser pedestal 44;

Box 58 indicates laser welding together of the panel 10 and reinforcements 14, 16, 18, 64;

Box 59 represents the vision inspection of the welded panel assembly 12.

At box 60, the welded panel assembly may be unloaded.

Box 62 represents the upper robot retracting from the upper pad/anvil hand off to the lower anvil and then moving to perform other operations.

Box 68 represents a vision system that may be stationary or picked up by one of the robots to inspect the flux application, loaded parts, and/or weld inspection.

Some alternate method steps are indicated by box 62, which allows temporary assignment of a robot to another operation, with return later to box 60 for pickup of another anvil. Other variations in the processing steps will be apparent to those skilled in the art.

Although the invention has been described by reference to a specific embodiment, it should be understood that numerous changes may be made within the spirit and scope of the inventive concepts described. Accordingly, it is intended that the invention not be limited to the described embodiment, but that it have the full scope defined by the language of the following claims.

What is claimed is:

1. A method of laser welding metal automotive panel assemblies, the method comprising:
loading a panel and parts to be welded thereto onto a support anvil;
engaging a pressure pad/clamping anvil against the panel and the parts to be welded thereto with adequate force on the support anvil and pressure pad/clamping anvil to maintain alignment of the panel and parts, the pressure pad including access locations for admitting laser welding beams to the panel and parts locations to be welded; and
actuating a laser welding gun to direct welding laser beams through the access locations and weld the parts and panel together into an assembly.

2. The method of claim 1 including releasing and removing the pressure pad/clamping anvil; and
unloading the welded panel assembly for use, further processing, or storage.

3. The method of claim 1 including, prior to welding, applying welding flux to the panel locations to be welded.

4. The method of claim 1 including applying locating and clamping devices to at least two locations between the anvils and applying adequate holding force while maintaining alignment of the anvils, resulting in positive fit up for welding.

5. The method of claim 4 wherein the clamping devices are actuated by at least one of pneumatic, hydraulic, electric and manual power developing high capacity holding forces.

6. The method of claim 1 wherein the access locations are small sized accurately positioned guide holes through the clamping anvil.

7. The method of claim 1 wherein at least the clamping anvil is positioned as an end of arm tool of a robot.

8. The method of claim 1 wherein loading on the support anvil of the panel and parts for welding thereto is performed by at least one of manual, mechanical and robot means.

9. A laser welding assembly comprising:
a support anvil;
a panel and parts to be welded loaded on the support anvil; and
a pressure pad/clamping anvil disposed against the panel and the parts to be welded with adequate force on the support anvil and pressure pad/clamping anvil to maintain alignment of the panel and parts, the pressure pad/clamping anvil including access locations for admitting laser welding beams to the panel and parts at locations to be welded.

10. The laser welding assembly of claim 9 including clamping devices applied to at least two locations between the support anvil and the pressure pad/clamping anvil.

11. The laser welding assembly of claim 10 wherein the clamping devices are actuated by at least one of pneumatic, hydraulic, electric, and manual power.

12. The laser welding assembly of claim 9 wherein the access locations are small sized accurately positioned guide holes through the clamping anvil.

13. The laser welding assembly of claim 9 wherein the clamping anvil is positioned as an end of arm tool of a robot.
